(19) United States
(12) Patent Application Publication
(10) Pub. No.: US 2006/0130262 A1
(43) Pub. Date: Jun. 22, 2006

(54) Quick release paint roller assembly

(75) Inventors: John Visk, Chicago, IL (US); Dennis M. Futo, Strongsville, OH (US); Scott A. Pyle, Vernon Hills, IL (US); Michael M. Sherman, Mooresville, NC (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Zibra, LLC, Mooresville, NC (US)

(21) Appl. No.: 11/182,222

(22) Filed: Jul. 15, 2005

Related U.S. Application Data
(63) Continuation-in-part of application No. 11/064,473, filed on Feb. 23, 2005.
(60) Provisional application No. 60/638,449, filed on Dec. 22, 2004.

(51) Int. Cl. B05C 17/02

(52) U.S. Cl. 15/230.11; 492/13; 492/19

(57) ABSTRACT

A quick-release paint roller having a roller cover that can be removed from a handle assembly without requiring the user to apply a force directly to the roller cover. The paint roller includes a tube-shaped roller cover having an outer surface of paint absorbing material and a rotatably mounted roller core. The roller cover is mounted on the roller core so as to be rotatable with the roller core. The roller core has a length less than the length of the roller cover such that a first end of the roller core is adjacent an end of the roller cover and a second end of the roller core is within the roller cover. The second end of the roller core includes a roller mounting device. The paint roller also has a handle assembly including a housing having an extension member configured to extend inside the roller core, the extension member having an opening configured to receive the roller mounting device. The handle assembly also has a latching mechanism that is movable between a latched position and a release position. The latching mechanism includes an actuator and a pair of catch bars, wherein when the actuator is in the latched position, the latching mechanism engages the roller mounting device to couple the roller core to the handle assembly and prevent movement of the roller cover in a direction along the axis of rotation away from the housing. When the actuator is in the release position, the roller mounting device is free of the latching mechanism, thus permitting the roller core and roller cover to be removed from the handle assembly.

### REFERENCE TO RELATED APPLICATION

This application is a Continuation-In-Part of and incorporates by reference U.S. application Ser. No. 11/064,473 entitled “Quick Release Paint Roller Assembly” filed Feb. 23, 2005 which claims priority under 35 U.S.C. §119(e) to U.S. Provisional Patent Application No. 60/638,449, filed Dec. 22, 2004.

### BACKGROUND OF THE INVENTION

1. Field of Invention

This invention relates a roller assembly for use in applying a coating to a surface, and more particularly, to a paint roller assembly.

2. Description of Related Art

It is known to use paint roller assemblies having a handle with a roller support and a rotatable roller cover to apply paint to a wall. Normally, the roller cover is removably mounted on the roller support so that the roller cover can be detached from the support after use and cleaned or replaced as desired. Additionally, the useful life of the roller cover is often quite limited when compared to that of the handle and roller support. As such, the roller cover is usually removed from the handle after each use.

Typically, roller covers are frictionally secured to the roller support. One disadvantage associated with this type of roller assembly, is that, in order to remove the roller cover from the roller support, it is usually necessary to grasp the outer surface of the roller cover and slide it off of the roller support. As the roller cover being removed is normally covered with wet paint, the process of removing the roller cover from the roller assembly can be messy and often leads to paint getting on the hands and clothes of the person removing the roller cover. If one waits until the paint on the roller cover dries before removing the cover, the paint between the roller cover and the roller support dries and seals the roller cover to the roller support. Thus, in order to remove the roller cover from the paint roller assembly it is sometimes necessary to break the dried paint away from the end caps of the roller support, thereby allowing the roller cover to be removed from the roller assembly. Alternatively, it may be necessary to slice, or cut the roller cover along a length thereof, allowing the roller cover to be peeled away from the roller assembly.

Based on the foregoing, it would be desirable to provide a paint roller assembly with a roller cover that can be removed quickly and easily without having to grasp or touch the paint-covered roller cover.

### SUMMARY OF INVENTIVE FEATURES

One embodiment of the invention is directed to a quick-release paint roller that permits a roller cover to be removed from the handle assembly without requiring the user to apply a force directly to the roller cover. The paint roller includes a tube-shaped roller cover having an outer surface of paint absorbing material and a rotatably mounted roller core. The roller cover is mounted on the roller core so as to be rotatable with the roller core. The roller core has a length less than the length of the roller cover such that a first end of the roller core is adjacent an end of the roller cover and a second end of the roller core is within the roller cover. The second end of the roller core includes a roller mounting device. The paint roller also has a handle assembly including a housing having an extension member configured to extend inside the roller core, the extension member having an opening configured to receive the roller mounting device. The handle assembly also has a latching mechanism that is movable between a latched position and a release position. The latching mechanism includes an actuator and a pair of catch bars, wherein when the actuator is in the latched position, the latching mechanism engages the roller mounting device to couple the roller core to the handle assembly and prevent movement of the roller cover in a direction along the axis of rotation away from the housing. When the actuator is in the release position, the roller mounting device is free of the latching mechanism, thus permitting the roller core and roller cover to be removed from the handle assembly.

Another embodiment of the invention is directed to a quick-release paint roller that permits a roller cover to be removed from the handle assembly without requiring the user to apply a force directly to the roller cover. The paint roller has a tube-shaped roller cover having an outer surface of paint applying material and a rotatably mounted roller core. The roller cover is mounted on the roller core so as to be rotatable therewith. The roller core has roller mounting means positioned within the roller cover for mounting the roller core. The paint roller also has a handle assembly including a housing having an extension member configured to extend inside the roller core, the extension member having an opening configured to receive the roller mounting device. The handle assembly also has latching means movable between a latched position and a release position. When the latching means are in the latched position, the latching means engage the roller mounting means to couple the roller core to the handle assembly and prevent movement of the roller cover in a direction along the axis of rotation away from the housing. When the latching means are in the release position, the latching means release the roller mounting means. A portion of the latching means extends from the housing to form an actuating surface located on the handle assembly away from the axis of rotation of the roller cover to thereby permit the roller cover to be removed from the handle assembly without requiring the user to apply a force directly to the roller cover.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of a roller assembly;

FIG. 2A is a perspective view of an alternate embodiment of a roller assembly;

FIG. 2B is an enlarged perspective view of the roller assembly of FIG. 2A illustrating a quick-release feature of the roller assembly;

FIG. 3 is a cutaway view of a roller assembly of FIG. 2A illustrating the latching mechanism of the roller assembly;

FIG. 4 is a partly in section view of the roller cover of the roller assembly of FIG. 2A;

FIG. 5A is an enlarged side view of a trigger of the latching mechanism of the roller assembly of FIG. 2A;

FIG. 5B is an enlarged plan view of a trigger of the latching mechanism of the roller assembly of FIG. 2A;

FIG. 6 is a cutaway view of a roller assembly of FIG. 1 illustrating the latching mechanism of the roller assembly;

FIG. 7 is an exploded perspective view of another embodiment of a roller assembly;

FIG. 8A is cross-section of the roller assembly of FIG. 7 with the latching mechanism in a latched condition;

FIG. 8B is another cross-section of the roller assembly of FIG. 7 with the latching mechanism in a latched condition;

FIG. 9A is cross-section of the roller assembly of FIG. 7 with the latching mechanism in an unlatched condition;

FIG. 9B is another cross-section of the roller assembly of FIG. 7 with the latching mechanism in an unlatched condition;

FIG. 10 is a side view of the roller core 141 of the roller assembly of FIG. 7;

FIG. 11 is a plan view of the actuator of the roller assembly of FIG. 7; and

FIG. 12 is a side view of the catch arms of the actuator of the roller assembly of FIG. 7.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

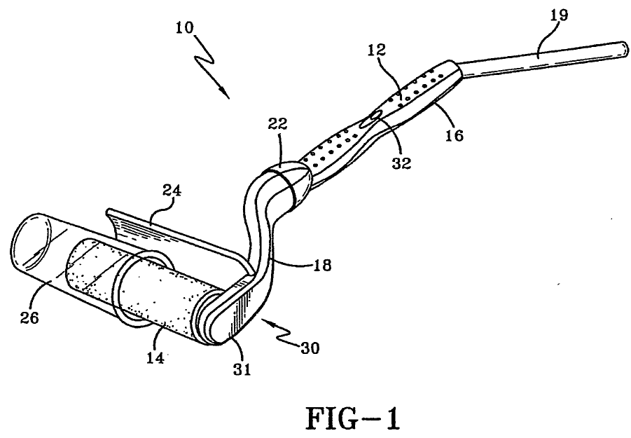

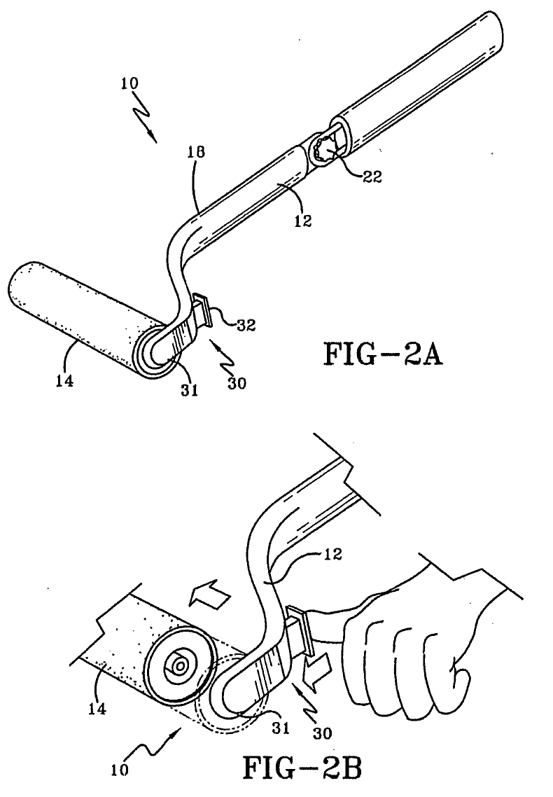

Referring now to FIGS. 1 and 2, the invention is directed to a roller tool assembly generally designated by the reference number 10 for use in applying paint or other product to a work surface. The paint roller 10 includes a handle assembly generally designated by the reference numeral 12 and a roller cover 14 rotatably coupled thereto. The handle assembly 12 includes a hand grip 16 useful for gripping the paint roller 10 and a generally S-shaped housing 18 attached to the hand grip 16 for rotatably latching the roller cover 14. Desirably, the hand grip 16 is a soft grip overmold ergonomic handle grip to improve comfort while in use. Alternatively, other hand grips known in the art may be used without departing from the scope of the invention. The hand grip 16 is secured to the housing 18 with a set screw 20. However, the invention is not limited in this regard, as other types of fasteners, such as adhesives or rivets could be utilized to attach the housing 18 to the hand grip 16, or the housing 18 can be manufactured integral to the hand grip 16.

The handle assembly 12 desirably has a length of about 18 inches for one or two handed use. In the embodiment illustrated in FIG. 1, a telescoping soft grip handle 19 slides out of the hand grip 16 for additional handle length for hard to reach areas. Accordingly, the total length this embodiment of the paint roller tool 10 is desirably between about 35 inches to about 45 inches during maximum extension mode. However, one skilled in the art will recognize that any handle length may be used without departing from the scope of the invention. Desirably, the handle assembly 12 also includes a multi-position lateral swivel feature 22 with lock detail for improved usage. While materials for the handle assembly 12 are not intended to be limiting, preferably the handle assembly 12 is manufactured of a material such as aluminum or plastic for providing a high performance and durable paint roller 10. An optional splash guard 24 may extend between the roller cover 14 and the hand grip 16 as is known in the art. Additionally, an optional snap-over roller saver 26 is provided whereby wet paint on the roller can be temporarily stored for short periods of time (i.e., a drying stage or until the next day).

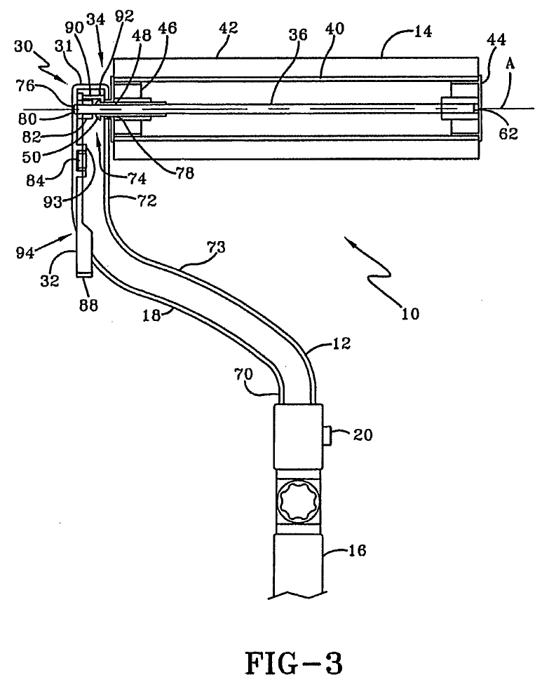

Referring now to FIGS. 1-3, according to the invention, the paint roller tool 10 includes a “hands-free” quick-release feature that quickly detaches the roller cover 14 from the handle assembly 12 through an internal latching mechanism 30 that extends from near the hand grip 16 area to a roller cover mounting end 31 of handle assembly 12. FIG. 1 illustrates the latching mechanism 30 comprising an actuator 32 in the form of a roller-eject slide switch, which, when actuated, causes the automatic releasing and ejection of the roller cover 14 to an extended position relative to the housing 18, to thereby at least partially decouple the roller cover 14 from the handle assembly 12. FIG. 2A illustrates the latching mechanism 30 with the actuator 32 in the form of a trigger which can be depressed as illustrated in FIG. 2B for actuating the quick-release feature. Although the embodiments in FIGS. 1 and 2 illustrate different methods for actuating the latching mechanism 30, and other means may be used using sound engineering judgment without departing from the scope of the invention, the resulting hands-free removal feature is substantially identical. As best seen in FIG. 3, the housing 18 of the handle assembly 12 includes a roller support, generally designated by the reference numeral 34, including a roller mounting shaft 36 on which the roller cover 14 is rotatably received. The mounting shaft 36 extends from the housing 18 along an axis A which is substantially coaxial with the axis of rotation of the roller cover 14. The axis A of the mounting shaft 36 is also generally perpendicular to the axis of the hand grip 16. Actuation of this quick-release feature automatically releases roller cover 14 thus eliminating the need for the user to have to handle the paint saturated roller cover 14 in order to remove the roller cover 14 from the handle assembly 12. The terms “automatic”, “hands-free” and “quick-release” as used herein with respect to the latching mechanism 30 mean that the decoupling of the paint roller cover 14 from the handle assembly 12 occurs without requiring the user to apply a manual force directly to the paint roller cover 14. In other words, although a force is required to be applied to the latching mechanism 30 to initiate the decoupling process, the actual force decoupling the roller from the handle assembly 12 is provided by means other than manual force applied by the user to the roller cover 14, as will be set forth more fully below.

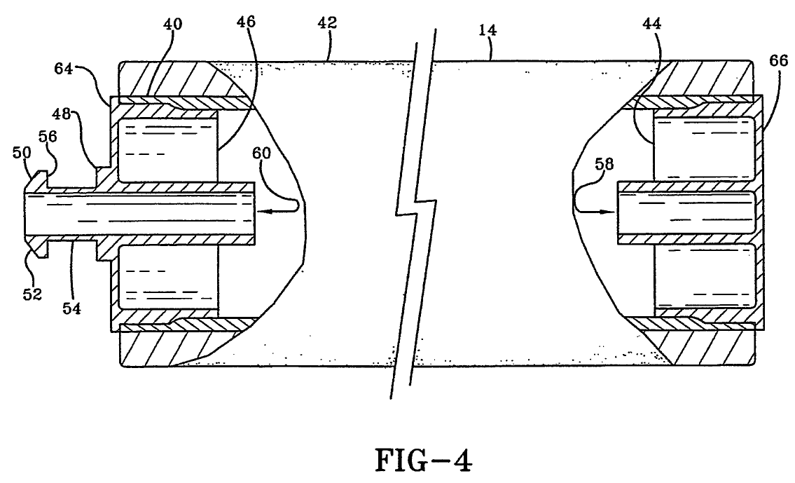

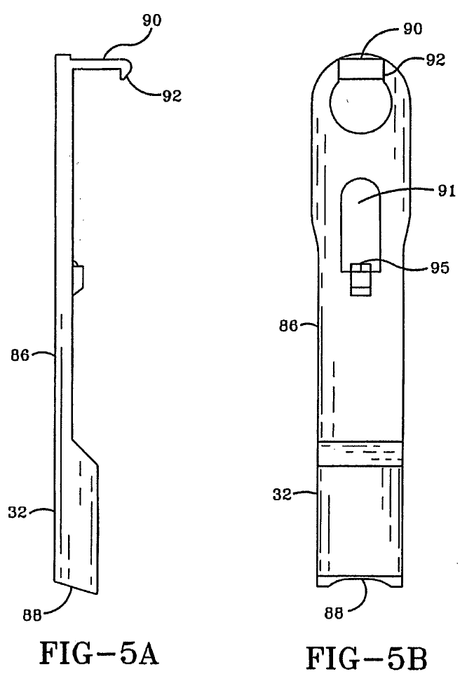

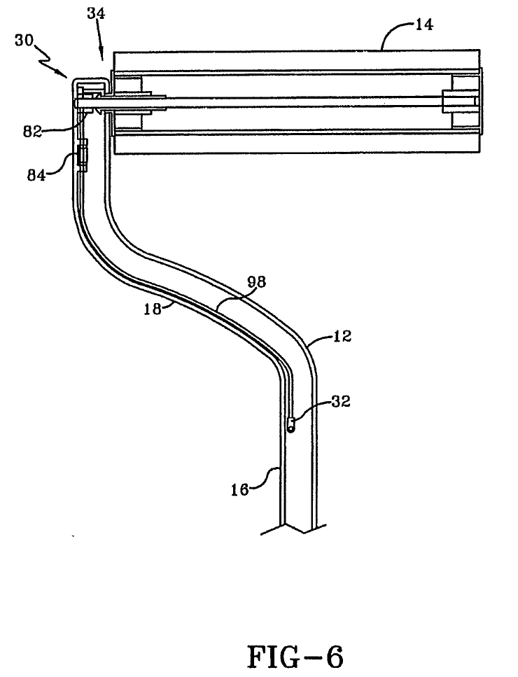

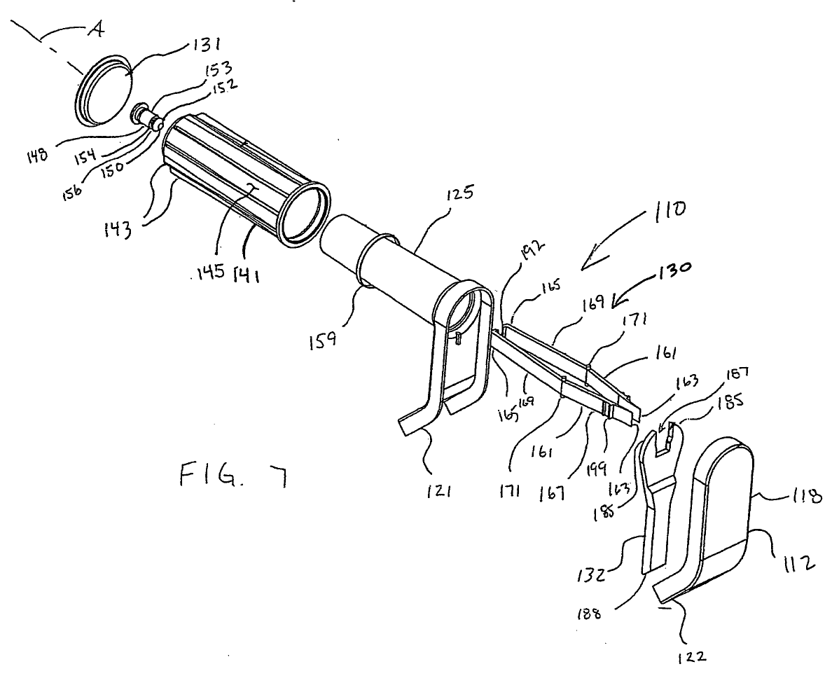

As best seen in the enlarged view of FIG. 4, the roller cover 14 includes a roller tube 40 with an outer circumferential surface material 42 for carrying paint or other material to be applied to the work surface. Desirably, the surface material 42 is made of sponge, cotton, synthetic fibers, wool or the like and is highly capable of absorbing the paint or other liquid to be applied. The roller cover 14 also has a pair of end caps, including an outer end cap 44 and an inner end cap 46 disposed and fitted in opposing ends of the roller tube 40. The inner end cap 46 comprises hub 48 having a nipple 50 extending there from generally along the rotational axis A of the roller cover 14. The nipple 50 has a rounded head 52 and an annular groove 54 around the base thereof forming a ridge surface 56. The outer end cap 44 and inner end cap 46 define axial bores 58, 60 respectively, sized to provide a bearing surface for rotation of the roller cover 14 about the mounting shaft 36 of the roller support 34 as illustrated in FIG. 3. The mounting shaft 36 is received through axial bore 60 in the inner end cap 46 and a distal end 62 of the mounting shaft 36 is received in the axial bore 58 in the outer end cap 44 for receiving the roller cover 14 on the roller support 34 of the handle assembly 12. Preferably, the inner and outer end caps 44, 46 are manufactured from a synthetic polymeric material, such as nylon, polyethylene or other molded plastic. As shown in FIG. 4, the inner and outer end caps 44, 46 include a cap face 64, 66 for preventing paint from entering the hollow interior of the roller cover 14. The diameter of the end face 64, 66 is larger than the diameter of the portion of the end cap 44, 46 for engaging the roller tube 40 of the roller cover 14. The roller cover 14 desirably has a width and a diameter substantially equally to those of a standard 9-inch roller. However, other widths, such as 4 inches, and diameters may be used without departing from the scope of the invention.

As best seen in FIG. 3, the housing 18 is desirably a generally elongated tubular member having a generally S-shape such that a first leg 70 is generally aligned with the hand grip 16 and a second leg 72 is parallel to the first leg 70 but offset such that the hand grip 16 is positioned along an axis extending from or near the midpoint of the roller cover 14. A midsection 73 joins the first leg 70 and second leg 72 to form the generally S-shaped housing 18. The housing 18 forms a channel 74 which is defined by the interior surfaces of the housing 18. The roller mounting shaft 36 has an end portion 76 disposed in a bore 78 in the housing 18 leading to the channel 74 and is attached to the housing 18 with a screw 80 or other fastening device. Alternately, the shaft 36 can be insert molded into a boss (not shown) in the housing 18 or the end of the shaft can be threaded and screwed into a female thread in a boss in the housing. The channel 74 is also adapted to receive at least a portion of the latching mechanism 30 and the nipple 50 of the roller cover 14 as described below.

In the embodiment illustrated in FIGS. 2 and 3, the latching mechanism 30 includes the trigger 32, an ejector spring 82 and a latch spring 84. As best seen in FIGS. 5A and 5B, the trigger 32 includes an elongate body 86 having an actuating surface 88 at a proximal end and a latch 90 protruding from a distal end thereof. The latch 90 includes a detent 92 at the outer end thereof. In the latched condition, as depicted in FIG. 3, the latch 90 engages the nipple 50 of the inner end cap 46 to secure the roller cover 14 on the roller support 34. The detent 92 fits into the annular groove 54 and contact with the ridge 56 on the nipple 50 prevents movement of the roller cover 14 in the outward direction along the axis of rotation A of the roller cover 14. The trigger 32 is partially disposed inside the housing 18 such that the actuating surface 88 extends outwardly from an opening 94 in the housing 18 so that it can be pushed by the user to automatically uncouple the roller cover 14 as depicted in FIG. 2B. The illustrated embodiment shows a male/female relationship of the surface of the latch detent 92 and the groove 54 on the nipple 50, however, one skilled in the art will understand that this relationship may be reversed without departing from the scope of the invention.

The latch spring 84 is disposed in the chamber 74 of the housing 18 and urges the trigger 32 toward a neutral position. Desirably, the neutral position of the trigger 32 is the latched condition illustrated in FIG. 3. As best seen in FIG. 5B, in one embodiment, the body 86 of the trigger 32 has a window 91 formed therein and the latch spring 84 is positioned within this window. As illustrated in FIG. 3, the latch spring is retained in the window 91 with one end of the latch spring received on a nub 95 formed on the body 86. The other end of the latch spring contacts a protrusion 93 extending from the inner wall of the housing 18 protruding through the window 91. In the neutral position shown, the latch spring 84 exerts a force on the trigger 32 causing the detent 92 to engage the annular groove 54 in order to retain the roller cover 14. The roller cover 14 is released by the latching mechanism 30 by applying a force on the trigger 32 to overcome the force of the latching spring 84 and move the trigger into a release position wherein the detent 92 moves out of the annular groove 54 so that the latch 90 is free of the nipple 50.

The ejector spring 82 is disposed between the body 86 of the trigger 32 and the head 52 of the nipple 50. Desirably, the ejector spring 82 resides within an upper aperture formed in the trigger 32 and will bear against a surface molded in the housing 18 and against the nipple 50. The ejector spring 82 is biased to urge the nipple 50 out of the chamber 74 of the housing 18 so as to eject the roller cover 14. However, as long as the trigger 32 is in the latched condition, the latch 90 retains the nipple 50 in the housing 18 against the bias of the ejector spring 82 and the roller cover 14 remains on the roller support 34. When the trigger 32 is actuated and the detent 92 clears the ridge 56 on the nipple 50, the ejector spring 82 forces the nipple 50 out of the housing 18 and thus decouples the roller cover 14 from of the latching mechanism 30 so that the roller cover 14 can freely slide off the mounting shaft 36. Desirably, the hub 48 of the inner end cap 46 has a diameter only slightly smaller than the diameter of the bore 78 in the housing 18. Thus, when the roller cover 14 is in the latched condition, the hub 48 is received within the bore 78 in the housing 18 and forms a frictional fit that discourages paint from entering into the chamber 74 of the housing 18.

To mount a roller cover 14 to the handle assembly 12, the roller cover 14 is slid onto the roller support 34 by inserting the mounting shaft 36 through the axial bores 58, 60 in the end caps 44, 46. The nipple 50 on the inner end cap 46 is then inserted into the bore 78 in the housing 18. The rounded head 52 of the nipple contacts the detent 92 on the trigger 32 causing the latch 90 to move upwards against the biasing force of the latching spring 84. When the detent 92 passes the head 52, it snaps into the annular groove 54. Thus, contact of the latch 90 against the ridge 56 of the nipple 50 keeps the roller cover 14 from leaving the roller support 34, yet permits the roller cover 14 to freely rotate on the mounting shaft 36 in order to apply the paint to the work surface. When it is desired to remove the roller cover 14 from the handle assembly 12, the user simply presses on the actuating surface 88 of the trigger 32 and urges the trigger against the spring force provided by the latch spring 84. This causes the latch 90 to move toward the end 31 of the housing 18 until the detent 92 clears the ridge 56 on the nipple 50 of the roller cover 14. When the detent 92 clears the ridge 56, the ejector spring 82 forces the nipple 50 out of the bore 78 in the housing 18 and the roller cover 14 is free to slide off the roller support 34. Therefore, pressing on the trigger 32 automatically ejects the roller cover 14 from the handle assembly 12 without requiring the user to come in contact with the wet paint covering the roller cover 14. Desirably, the nipple 50 allows the roller cover 14 to quickly be removed from the handle assembly 12 after only depressing the trigger 32 for the time required for the detent 92 to pass over the ridge 56 of the nipple 50.

Importantly, it is desirable that the actuating surface 88 of the trigger 32 be a sufficient distance from the end 31 of the housing 18 to reduce the likelihood that the actuating surface will be covered by paint. Paint rollers 10 are typically used by dipping the roller cover 14 into a tray filled with the paint to be applied to the work surface. As such, the end 31 of the housing 18 also may also come in contact with and be covered by the paint from the tray. Thus, the actuating surface 88 is desirably offset from the axis A of the roller cover 14 and mounting shaft 36 to position the actuating surface in a location that will not routinely come in contact with the paint. In the embodiment illustrated in FIG. 3, the actuating surface 88 of the trigger extends from the end of the second leg 72 of the S-shape of the housing 18 so that the actuating surface 88 is located in the region of the handle assembly 12 occupied by the midsection 73 of the housing 18. Thus, the actuating surface 88 is offset from the axis A by a distance of several inches, which is desirably at least 2 inches and more desirably at least 4 inches.

Turning now to FIG. 6, another embodiment of the paint roller 10 is illustrated. In this embodiment, the actuator 32 of the latching mechanism 30 is a roller-eject slide switch as depicted in FIG. 1. The slide switch 32 is connected to a solid spring-loaded shaft 98 that extends to the latch 90 internal to the housing 18. In this manner, the actuator is located proximate the hand grip 16 of the handle assembly 12. Sliding the slide switch 32 forward along the handle assembly 12 against a biasing force of the latch spring 84 causes the latching mechanism 30 to unlatch and eject the roller cover 14 as described above.

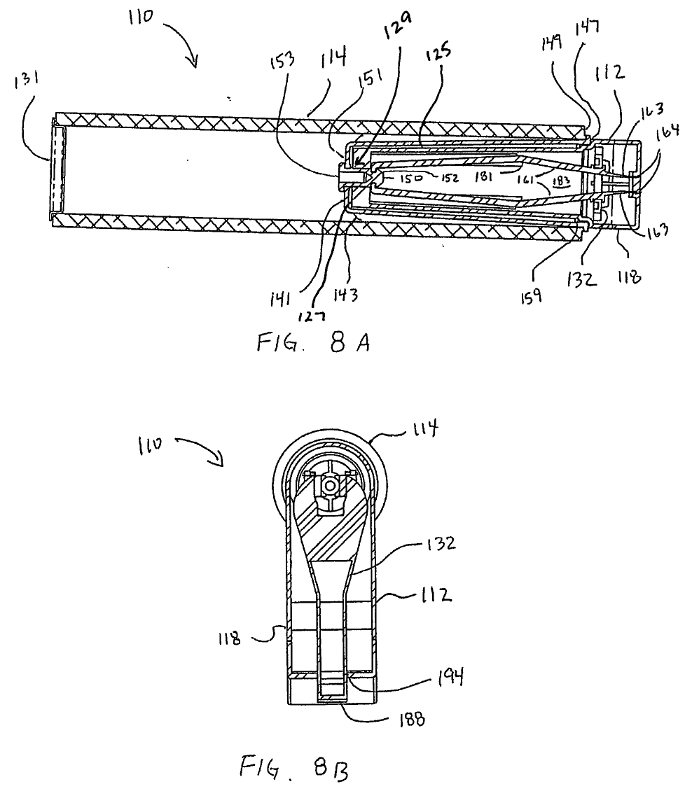

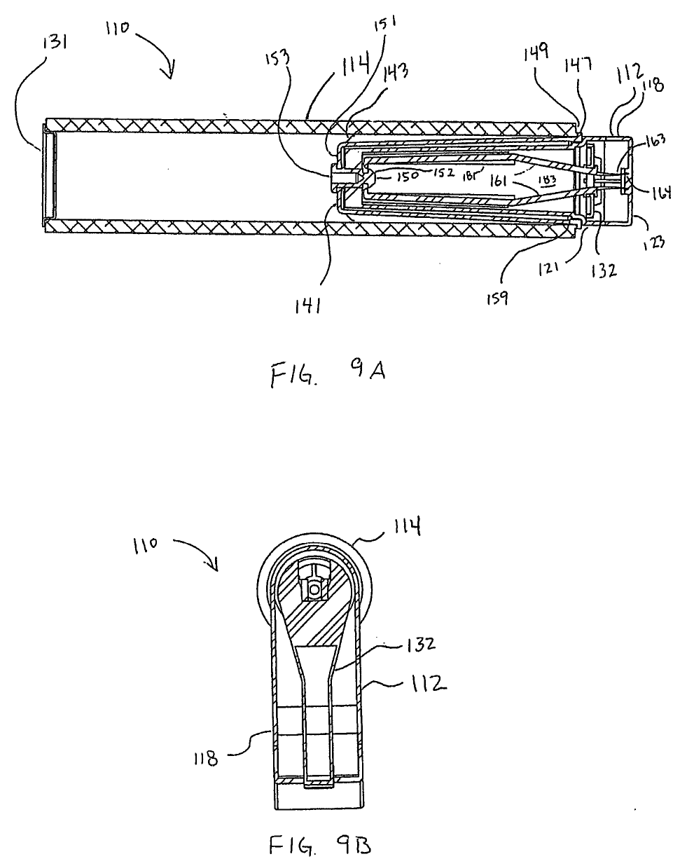

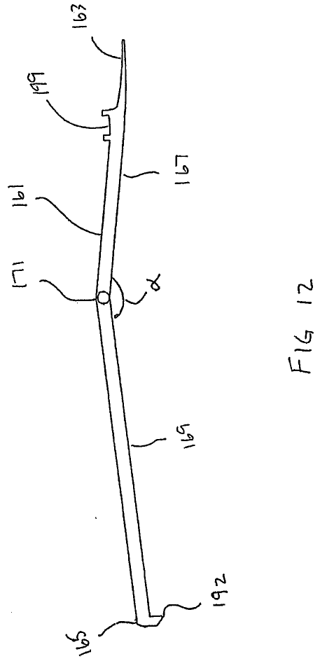

Referring now to FIGS. 7-12, another embodiment of a paint roller is illustrated at 110. The paint roller 110 includes a handle assembly generally designated by the reference numeral 112 and a roller cover 114 (FIGS. 8 and 9) rotatably coupled thereto. The handle assembly 112 may includes a hand grip (not shown) useful for gripping the paint roller 110 as depicted above. In the illustrated embodiment, the handle assembly 112 includes a housing 118 formed of an articulated inner frame 121 and outer frame 123. The inner frame 121 has an extension member 125 that extends inwardly generally along the rotational axis A of the roller cover 114. Desirably, the extension member 125 extends a length of between about 3 inches and about 5 inches from the inner frame 121. In the illustrated embodiment, the extension member 125 is a tapered tube having a slightly decreasing diameter when looking away from the inner frame 121. An end face 127 of the extension tube 125 has an opening 129 through which a roller mounting device is received as will be more fully discussed below. The extension tube 125 permits the roller mounting device to enter the opening 129 and connect to the roller handle assembly 112 inside the roller cover 114 to reduce the possibility of paint entering the opening and clogging the inside workings of the handle assembly 112. By connecting inside the roller cover 114, it is meant that the roller cover is connected to the handle assembly 112 with means that are located between the ends of the roller cover, and preferably near the middle of the length of the roller cover 114. The extension tube 125 may be molded as a uniform piece with the inner frame 121 or may be joined to the inner frame 121 through known joining methods, such as ultrasonic welding.

As is known, the roller cover 114 has an outer circumferential surface material 142 for carrying paint or other material to be applied to the work surface. Desirably, the surface material 142 is made of sponge, cotton, synthetic fibers, wool or the like and is highly capable of absorbing the paint or other liquid to be applied. The roller cover 114 desirably has a width and a diameter substantially equally to those of a standard 9-inch roller. However, other widths and diameters may be used without departing from the scope of the invention. A roller cap 131 is disposed and fitted in the outer end of the roller cover 114 for preventing paint from entering the hollow interior of the roller cover 114. As used herein pertaining to the roller cover 114 and other roller components, outer end refers to the end that is further from the handle assembly 112, and inner end refers to the end nearer the handle assembly 112.

The roller cover 114 is mounted on a roller core 141. As best seen in FIG. 8A, in one embodiment, the roller core 141 comprises a hollow tube with outwardly extending radial ridges 143 so that a snug frictional fit is formed when the roller core 141 is inserted into the roller cover 114. The inner end of the roller core 141 has a radially extending flange 147 that abuts the edge 149 of the roller cover 114 at its inner end when the roller cover 114 is completely inserted onto the roller core 141. The flange 147 provides a seal between the roller cover 114 and the roller core 141 at the inner end to substantially prevent paint from seeping between the roller cover 114 and roller core 141.

The outer end of the roller core 141 has an end face 151 that receives a roller mounting device 153. In the illustrated embodiment, the roller mounting device 153 is an axle that extends into the hollow interior of the roller core 141 and has a shaft 148 with a nipple 150 on its distal end. The nipple 150 has a rounded head 152 and an annular groove 154 around the base thereof forming a ridge surface 156. Desirably, the axle 153 is snap fit onto the outer face 151 of the roller core 141. The roller core 141 desirably has a length of about one half of the total length of the roller cover 114. For example, desirable lengths for the roller core 141 are between about 3 and about 5 inches in length. These lengths place the mounting device 153 in the interior of the roller cover 114 and away from the edges of the roller cover 114, and preferably near the mid-point of the roller cover 114, so that there is less of a possibility of paint contaminating or clogging the roller mounting device 153. By “away from the ends of the roller cover” and “near the mid-point of the roller cover 114” in this embodiment, it is meant that the roller mounting device 153 be positioned nearer to the mid-point of the roller cover 114 than to either of the ends of the roller cover 114. In another embodiment, the roller mounting device 153 is positioned at least about one inch from an edge of the roller cover 114, and more preferably, at least about three inches from an edge of the roller cover 114.

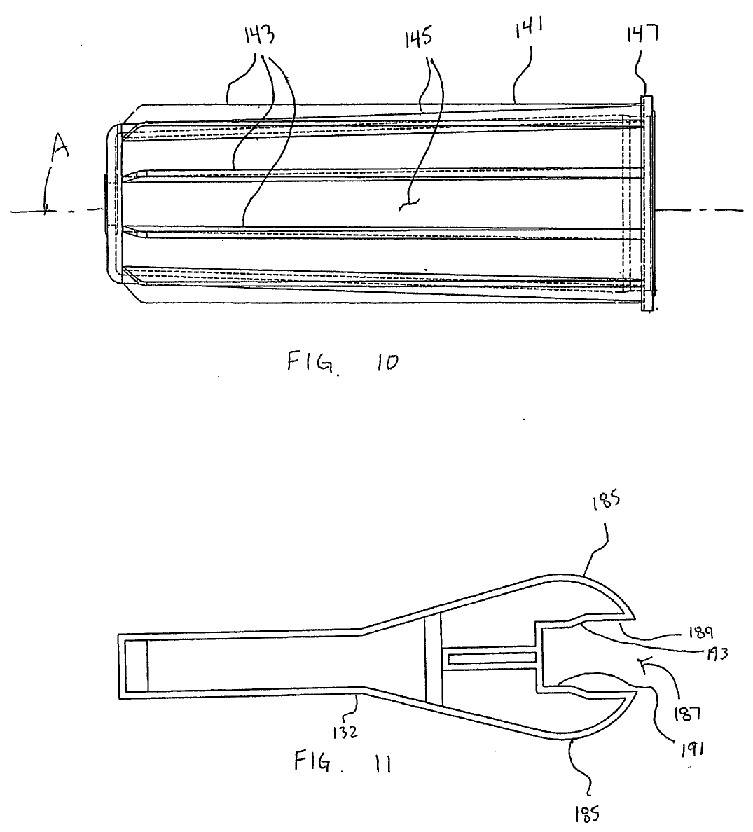

In the illustrated embodiment, as best seen in FIG. 10, the outer surface 145 of the roller core 141 is axially tapered such that the diameter of the roller core 141 at its inner end is greater than the diameter of the core at its outer end. However the outer diameter of the ridges 143 remains constant such that the ridges 143 become progressively more pronounced toward the outer end as best seen in FIG. 10. Preferably, the roller core 141 and axle 153 are manufactured using an injection molded nylon, polyethylene or other molded plastic. Other shapes for the roller core 141 may be used using sound engineering judgment. For example, the roller core can be formed of a plurality of rods forming a generally cylindrical cage to provide a mounting structure for the roller mounting device 153.

The axle 153 acts as an outer bearing surface for rotation of the roller core 141 and roller cover 114. A ring bearing 159 is placed on the extension tube 125 to provide an inner bearing surface for the roller core 141 to rotate on the extension tube 125. In one embodiment, the ring bearing 159 is desirably made of metal or other durable material with a low coefficient of friction. Thus, in one desirable embodiment, the stresses of using the roller cover 114 are distributed out into a large diameter circle and the bearing surfaces are plastic on metal at the large inner ring bearing 159 and plastic on plastic at the smaller axle 153, which typically bears less force. One skilled in the art will understand that the roller core 141 can be configured to function with commercially available roller covers 114 such that the roller core 141 can be removed from the roller cover 114 after use and inserted into a new roller cover 114, or the roller core 141 can be designed as a disposable product preassembled with the roller cover 114 to be discarded with the used roller cover 114 after use.

The paint roller 110 includes a quick-release feature that quickly detaches the roller cover 114 from the handle assembly 112 through an internal latching mechanism 130. Actuation of this quick-release latching mechanism 130 automatically releases the roller cover 114, thus eliminating the need for the user to have to handle the paint saturated roller cover 114 in order to remove the roller cover 114 from the handle assembly 112. The latching mechanism 130 comprises a pair of opposed catch bars 161 that combine to retain the roller core 141 on the handle assembly 112. A proximate end 163 of each catch bar 161 is secured to the housing 118 to restrict the catch bar 161 from moving laterally. The ends 163 can be placed in grooves 164 in the outer frame 123 to attach the catch bars 161 to the housing 118 or attached using other means. Desirably, the proximate ends 163 are laterally secured to the housing 118 so that the catch bars 161 are allowed to flex at their proximate ends. A distal end 165 of the catch bar 161 contains a detent 192 extending inward from the end thereof. The catch bar 161 is desirably made of two legs 167, 169 joined at a pivot 171 forming an obtuse angle α In the illustrated embodiment, the first leg 167 is shorter than the second leg 169 and desirably has a length between about 1.2 and 1.7 inches and more preferably about 1.4 inches. The second leg 169 is longer than the first leg 167 and desirably has a length of between about 2.0 and 2.7 inches and more preferably about 2.4 inches. The angle α is preferably in the range of between about 140 and about 175 degrees, and more desirably between about 150 and 170 degrees. However, these dimensions are for example purposes only, and other dimensions and geometries may be used using sound engineering judgment. The pivot 171 contacts a protrusion 181 on the inner surface 183 of the extension tube 125. Desirably, the catch bar 161 are retained at the pivot 171, but allowed to rotate.

An actuator 132, in the form of a roller-eject push button, interfaces with the catch bars 161 and is used to actuate the catch bars 161 in order to release roller core 141 and decouple the roller cover 114 from the handle assembly 112. One end of the actuator 132 has a pair of forks 185 forming a notch 187. The forks 185 of the actuator 132 are formed such that the notch 187 has a wider outer portion 189 and a narrower inner portion 191. Ramp 193 connects the inner portion 191 to the outer portion 189. The actuator 132 is partially disposed inside the housing 118 such that an actuating surface 188 extends outwardly from an opening 194 in the housing 118. Desirably, a return spring (not shown) pushes the actuator 132 into the latched position. The actuating surface 188 is pushed by the user to automatically uncouple the roller cover 114. Desirably, the actuating surface 188 is offset from the axis of rotation of the roller cover 114 by at least 2 inches, and more preferably by at least 3 inches so that the actuating surface 188 is remote from portions of the roller 110 that come in contact with the paint so that the actuating surface remains free of paint. The catch bars 161 are made of plastic and are self springing to bias the catch bars 161 into a latched condition to retain the roller core 141. In one embodiment, the proximate ends 163 of the catch bars 161 are formed with thin and tapered thicknesses. This allows these ends 163 to flex without overstressing the material, thereby acting as leaf springs to bias the catch bars 161 into their latched position.

In the latched condition, as depicted in FIGS. 8A and 8B, the actuator 132 is in a first position such that the catch bars 161 are received in the wider outer portion 189 of the notch 187 in the actuator 132. The detents 192 of catch bars 161 fit into the annular groove 154 and contact with the ridge 156 on the nipple 150 of the axle 153 to secure the roller core 141, and thus the roller cover 114, to the handle assembly 112. The detents 192 thus prevent movement of the roller core 141 in the outward direction along the axis of rotation A of the roller cover 114. The roller core 141, and thus the roller cover 114, is freely rotatable in this latched condition, with the roller core 141 rotating on the axle 153. Additionally, an ejection spring (not shown) for ejecting the roller cover 114 can be located within the handle extension 125 on the center axis of the mechanism and acting on the end surface 150 of the axle 153.

In the unlatched condition, as depicted in FIGS. 9A and 9B, the actuator 132 is depressed against the latch return spring force into a second position relative the catch bars 161 such that the catch bars 161 are forced into the narrower inner portion 191 of the notch 187 in the actuator 132. Forcing the catch bars 161 into the inner portion 191 of the notch 187 pinches the first legs 167 of the catch bars 161 closer together. As the first legs 167 of the catch bars 161 are pinched together, the catch bars 161 pivot about the pivots 171 causing the distal ends 165 to separate. With the distal ends 165 in this separated position, the detents 192 of catch bars 161 no longer engage the nipple 150 of the axle 153. This releases the roller core 141, and thus permits the roller cover 114 to be freely removed from the handle assembly 112. The actuator 132 slides up and down relative to the catch bars 161 in channels 199 molded into the catch bars 161. Desirably, the actuator 132 is restricted to move in a single plane by features molded internal to the housing surfaces 121 and 123.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A quick-release paint roller comprising:
a tube-shaped roller cover having an outer surface of paint absorbing material;
a rotatably mounted roller core, wherein the roller cover is mounted on said roller core so as to be rotatable with said roller core, the roller core having a length less than the length of the roller cover such that a first end of said roller core is adjacent an end of the roller cover and a second end of said roller core is located within the roller cover, and wherein the second end of the roller core comprises a roller mounting device;
a handle assembly comprising:
a housing having an extension member configured to extend inside said roller core, the extension member having an opening configured to receive the roller mounting device;
a latching mechanism movable between a latched position and a release position, said latching mechanism comprising an actuator and a pair of catch bars, wherein when the actuator is in the latched position, the latching mechanism engages the roller mounting device to couple the roller core to the handle assembly and prevent movement of the roller cover in a direction along the axis of rotation away from the housing, and wherein when the actuator is in the release position, the roller mounting device is free of the latching mechanism, permitting the roller core and roller cover to be removed from the handle assembly.

2. The paint roller as defined in claim 1 wherein the actuator has an elongate body, wherein one end of the actuator extends from an opening in the housing and forms an actuating surface, such that a force applied to the actuating surface moves said actuator between the latched position and release position so as to remove said roller cover from the handle assembly.

3. The paint roller as defined in claim 2 wherein the actuating surface is offset from the axis of rotation of the roller cover by at least three inches.

4. The paint roller as defined in claim 1 wherein the housing comprises an inner frame, wherein the extension member extends inwardly a length of between about 3 inches and about 5 inches from the inner frame.

5. The paint roller as defined in claim 4 wherein the extension member is in the shape of a tube with an end face having said opening formed therein.

6. The paint roller as defined in claim 1 wherein the roller mounting device comprising an axle having a nipple extending therefrom, said nipple having a head portion and an annular groove, and wherein the catch bars engage the annular groove of the nipple to couple the roller core to the handle assembly and prevent movement of the roller cover in a direction along the axis of rotation away from the housing, and wherein when the actuator is in the release position, the catch bars are free of the nipple.

7. The paint roller as defined in claim 6 wherein the actuator comprises a pair of forks forming a notch, wherein the forks are formed such that the notch has a wider outer portion and a narrower inner portion.

8. The paint roller as defined in claim 7 wherein in the latched condition, the actuator is in a first position such that the catch bars are received in the wider outer portion of the notch in the actuator such that detents of the catch bars fit into the annular groove and contact with the ridge on the nipple of the axle to secure the roller core to the handle assembly to prevent movement of the roller core in the outward direction along the axis of rotation A of the roller cover but permit the roller core to be freely rotatable with the roller core rotating on the axle.

9. The paint roller as defined in claim 8 wherein in the unlatched condition, the actuator is depressed into a second position relative the catch bars such that the catch bars are forced into the narrower inner portion of the notch in the actuator 132 thereby pinching the first legs of the catch bars closer together causing the catch bars to pivot about the pivots thereby causing the distal ends to separate such that the detents of catch bars no longer engage the nipple of the axle and permitting the roller core to be removed from the handle assembly.

10. The paint roller as defined in claim 1 wherein the second end of the roller core is near the midpoint of the roller cover.

11. The paint roller as defined in claim 10 wherein latching mechanism comprises a pair of opposed catch bars that combine to retain the roller core on the handle assembly.

12. The paint roller as defined in claim 11 wherein a proximate end of each catch bar is restricted from moving laterally with respect to the housing and a distal end of each catch bar comprises a detent extending from the end thereof.

13. The paint roller as defined in claim 12 wherein each catch bar comprises two legs joined at a pivot forming an obtuse angle α, wherein the first leg is shorter than the second leg the angle α is preferably in the range of between about 150 degrees and about 170 degrees.

14. A quick-release paint roller comprising:
a tube-shaped roller cover having an outer surface of paint applying material;
a rotatably mounted roller core, wherein said roller cover is mounted on said roller core so as to be rotatable therewith, the roller core having a roller mounting device positioned within the roller cover and near the midpoint of said roller cover;
a handle assembly comprising:
a housing having an extension member configured to extend inside said roller core, the extension member having an opening configured to receive the roller mounting device;
a latching mechanism movable between a latched position and a release position, said latching mechanism comprising an actuator and at least one catch bar, wherein when the actuator is in the latched position, the catch bar engages the roller mounting device to couple the roller core to the handle assembly and prevent movement of the roller cover in a direction along the axis of rotation away from the housing, and wherein when the actuator is in the release position, the catch bar is free of the roller mounting device, wherein the actuator extends from the housing to form an actuating surface located on the handle assembly away from the axis of rotation of the roller cover to thereby permit the roller cover to be removed from the handle assembly without requiring the user to apply a force directly to the roller cover.

15. The paint roller as defined in claim 14 wherein the housing comprises an inner frame and the extension member is in the shape of a tube with an end face having said opening formed therein, wherein the extension member extends inwardly a length of between about 3 inches and about 5 inches from the inner frame.

16. The paint roller as defined in claim 14 wherein latching mechanism comprises a pair of opposed catch bars, each catch bar having a distal end comprising a detent, and the actuator comprises a pair of forks forming a notch, wherein the forks are formed such that the notch has a wider outer portion and a narrower inner portion.

17. The paint roller as defined in claim 16 wherein the roller mounting device comprising an axle having a nipple extending therefrom, said nipple having a head portion and an annular groove, and wherein the catch bars engage the annular groove of the nipple to couple the roller core to the handle assembly and prevent movement of the roller cover in a direction along the axis of rotation away from the housing, and wherein when the actuator is in the release position, the catch bars are free of the nipple.

18. The paint roller as defined in claim 17 wherein each catch bar comprises two legs joined at a pivot forming an obtuse angle α, wherein the first leg is shorter than the second leg the angle α is preferably in the range of between about 150 degrees and about 170 degrees.

19. The paint roller as defined in claim 17 wherein in the latched condition, the actuator is in a first position such that the catch bars are received in the wider outer portion of the notch in the actuator such that detents of the catch bars fit into the annular groove and contact with the ridge on the nipple of the axle to secure the roller core to the handle assembly to prevent movement of the roller core in the outward direction along the axis of rotation A of the roller cover but permit the roller core to be freely rotatable with the axle rotating between the detents, and wherein in the unlatched condition, the actuator is depressed into a second position relative the catch bars such that the catch bars are forced into the narrower inner portion of the notch in the actuator 132 thereby pinching the first legs of the catch bars closer together causing the catch bars to pivot about the pivots thereby causing the distal ends to separate such that the detents of catch bars no longer engage the nipple of the axle and permitting the roller core to be removed from the handle assembly.

20. A quick-release paint roller comprising:
a tube-shaped roller cover having an outer surface of paint applying material;
a rotatably mounted roller core, wherein said roller cover is mounted on said roller core so as to be rotatable therewith, the roller core having roller mounting means positioned within the roller cover for mounting the roller core;
a handle assembly comprising:
a housing having an extension member configured to extend inside said roller core, the extension member having an opening configured to receive the roller mounting device;
latching means movable between a latched position and a release position, wherein when the latching means are in the latched position, the latching means engage the roller mounting means to couple the roller core to the handle assembly and prevent movement of the roller cover in a direction along the axis of rotation away from the housing, and wherein when the latching means are in the release position, the latching means release the roller mounting means, wherein a portion of the latching means extends from the housing to form an actuating surface located on the handle assembly away from the axis of rotation of the roller cover to thereby permit the roller cover to be removed from the handle assembly without requiring the user to apply a force directly to the roller cover.
